(19) United States
(12) Patent Application Publication
(10) Pub. No.: US 2025/0303209 A1
(43) Pub. Date: Oct. 2, 2025

(54) DUSTPROOF SPRINKLERS

(71) Applicant: Jong Ho KIM, Hwaseong-si, Gyeonggi-do (KR)

(72) Inventors: Jong Ho KIM, Hwaseong-si (KR); So Yeon JEON, Hwaseong-si (KR)

(21) Appl. No.: 18/033,111

(22) PCT Filed: Nov. 17, 2022
(86) PCT No.: PCT/KR2022/018239

§ 371 Date: Jun. 18, 2025

(30) Foreign Application Priority Data
Nov. 2, 2022 (KR) 10-2022-0144517

(51) Int. Cl. A62C 35/68; A62C 3/00

(52) U.S. Cl. CPC A62C 35/68; A62C 3/00

(57) ABSTRACT

The invention relates to a dustproof sprinkler, the present invention aims to maximize the dustproof performance of sprinklers installed in facilities requiring extreme dustproofing, such as clean rooms, by making the headnipple descend when it is supported on the headnipple support, thereby greatly strengthening the sealing force of the shield ring that closes the gap between the outer circumference of the headnipple and the inner circumference of the through hole of the ceiling member through the compression means of the headnipple.

### FIELD OF THE INVENTION

The present invention relates to a dustproof sprinkler, and more particularly to a dustproof sprinkler that, when installed in a facility that requires dustproofing, such as the a semiconductor clean room, does not impair the dustproofing requirements of the facility due to installation, and maximizes the dustproofing performance of the facility after installation.

### DESCRIPTION OF RELATED ART

In recent years, as the construction of facilities that require extreme dustproofing, such as semiconductor clean rooms, has increased, the requirement for dustproofing is also increasing in the installation of sprinklers as an early response to fire in facilities.

In this regard, prior to inserting the headnipple 103 into the through hole of the ceiling member C, an O-ring 111 is fitted to the outer surface of the headnipple 103 to seal the gap g between the outer surface of the headnipple 103 and the inner surface of the through hole, as shown in FIG. 1, In this case, in order to position the O-ring 111 in the gap g as shown in FIG. 1, the gap g must be sufficiently secured by the thickness of the O-ring 111, which in turn reduces the adhesion of the contact surface between the O-ring 111 and the gap g, thereby worsening the sealing performance of the O-ring 111.

In the flexible tube 201 for a sprinkler disclosed in Patent No. 10-2183779, filed herein, a sprinkler S is arranged in a grid of mold bars M through a fixed projection of a ceiling member C, as shown in FIG. 2, inserting a headnipple 203 connected to an end of a bendable conduit 205 into a through hole in the ceiling member C, leaving the head exposed, and supporting the headnipple 203 through a headnipple support 207, The headnipple 203 is threaded into a retaining ring 221 in the center of the headnipple support 207, and the headnipple support 207 is secured to the mold bar M via bolts 217 threaded into rails R formed in the top corners of the mold bar M.

In this case, the headnipple 203 has a ring groove 235 formed at the bottom of its outer circumferential surface for winding an o-ring 211, which is intended to seal the top of the gap g between the headnipple 103 and the ceiling member C, as shown in FIG. 3.

However, the sealing of the above gap (g) by the O-ring (211) had a problem that the sealing force was weak due to the property of the O-ring (211) to be elastically wound on the ring groove (235), and the structure that the gap (g) between the outer surface of the headnipple (203) and the inner surface of the through hole of the ceiling member (C) had to be pressed down from top to bottom.

In addition, in order to prevent the oil 211 being pushed downward from the ring groove 235 and being pushed upward, it is necessary to increase the adhesion force to the ring groove 235, and to do so, the inner diameter of the O-ring 211 is smaller than the outer diameter of the ring groove 235 so that it is strongly adhered to by tensile force when it is inserted into the ring groove 235, The problem is that the O-ring 211, which is subjected to a large internal stress, becomes less elastic over time, which not only weakens the sealing force against the gap g, but also eventually leads to fracture.

### SUMMARY OF THE INVENTION

### Technical Problem

The present invention is proposed to solve the above problems of conventional sprinklers, and aims to maximize the dustproof performance of sprinklers installed in facilities requiring extreme dustproofing, such as clean rooms, by making the headnipple descend when it is supported on the headnipple support, thereby greatly strengthening the sealing force of the shield ring that closes the gap between the outer circumference of the headnipple and the inner circumference of the through hole of the ceiling member through the compression means of the headnipple.

### Technical Solution

As a technical means for achieving the above-described technical problem, according to an aspect of the present invention, a dustproof sprinkler includes a headnipple connected to a water supply source above the ceiling member, the headnipple having a tapered end fitting into the ceiling member through a through hole; a head removably mounted on the other end of the headnipple, for spraying fire extinguishing water supplied through the headnipple from the water source; a headnipple support, coupled to extend outwardly from an outer surface of the headnipple, and removably secured to the ceiling member, thereby securing the headnipple to the ceiling member; a shield ring, formed to have an outer diameter greater than an inner diameter of the through hole, which is fitted to an outer circumferential surface of the headnipple at a position above the through hole to block the top of a gap that occurs between the through hole and the headnipple when the headnipple is inserted into the through hole; and a shield ring pressing means for compressing the shield ring to seal the top of the gap when the headnipple support is secured to the top of the ceiling member.

Further, the shield ring pressing means is preferably mounted liftably on the headnipple outer circumferential surface, so that the distance to the top of the gap can be adjusted to the thickness of the shield ring.

Further, the shield ring pressing means preferably comprises a ring flange having a female threaded hole machined in the center thereof, and a male threaded portion removably screwed into the female threaded hole to mount said ring flange liftably on the headnipple outer surface.

Further, the headnipple preferably comprises a recessed ring groove directly downstream of the male threaded portion for engaging and restraining the shield ring. Further, the ring flange is preferably inclined in the form of a lampshade so that the lower surface in contact with the shield ring is upwardly inclined the closer it is to the female threaded portion.

### Advantageous Effects

According to the dustproof sprinkler of the present invention, the headnipple can be moved downward through the headnipple support, so that the shield ring wound on the outer surface of the headnipple can be pressed through the pressing means when the headnipple is lowered, so that the top of the gap between the outer surface of the headnipple and the inner surface of the ceiling member through hole can be strongly pressed with the shield ring, so that the sealing force of the above gap can be greatly increased, and furthermore, it is possible to maximize the dustproof performance of the sprinkler for dustproof facilities such as clean rooms.

In addition, since the shield ring pressing means can be screwed to the headnipple through the ring flange and the male threaded part, the gap between the ring flange and the shield ring can be adjusted by rotating the ring flange, so that various thicknesses of shield rings can be adopted, and the compression strength of the shield ring can be changed when the shield ring is set, and as a result, the efficiency of the assembly work of the sprinkler, which must be performed while sealing the facilities requiring dustproofing such as clean rooms, can be greatly improved.

In addition, since the lower surface of the ring flange can be beveled upward as it moves inward, it is possible to deform the shield ring more inwardly through the effect of the beveled surface, thereby doubling the sealing power of the gap.

### BRIEF DESCRIPTION OF THE DRAWINGS

FIG. 1 is a partially enlarged view of a conventional sprinkler installed above a ceiling.

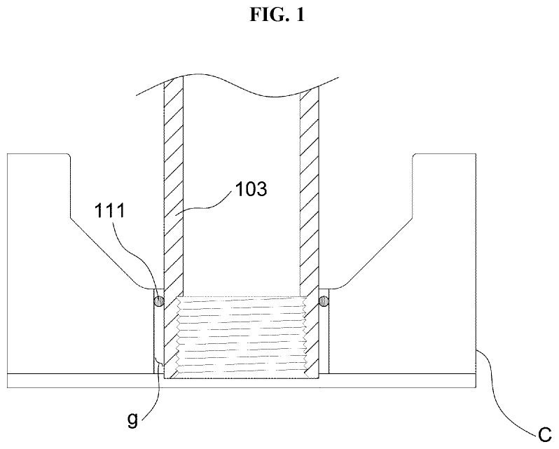

FIG. 2 is a perspective view depicting a conventional sprinkler installed above a ceiling in another state.

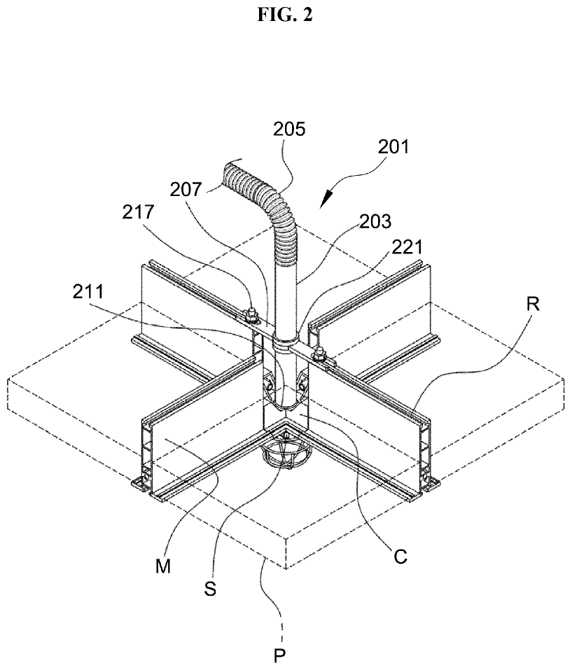

FIG. 3 is a partially enlarged view of FIG. 2.

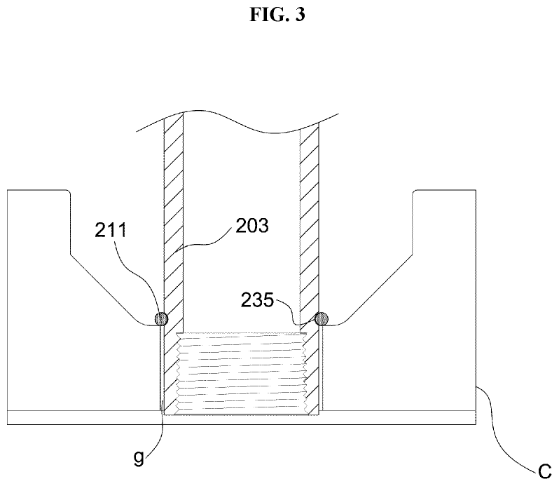

FIG. 4 is a perspective view of a dustproof sprinkler according to one embodiment of the present invention in a ceiling mounted state.

FIG. 5 is an exploded perspective view of FIG. 4.

FIG. 6 is a bottom perspective view of the headnipple and headnipple support of FIG. 4.

FIG. 7 is a longitudinal perspective view of FIG. 6.

FIG. 8 is a partial cross-sectional view showing another embodiment of the ring flange shown in FIG. 7.

FIG. 9 is a perspective view of the ceiling member shown in FIG. 4.

### DETAILED DESCRIPTION OF THE PREFERRED EMBODIMENT

A dustproof sprinkler according to an embodiment of the present invention will now be described in detail with reference to the accompanying drawings.

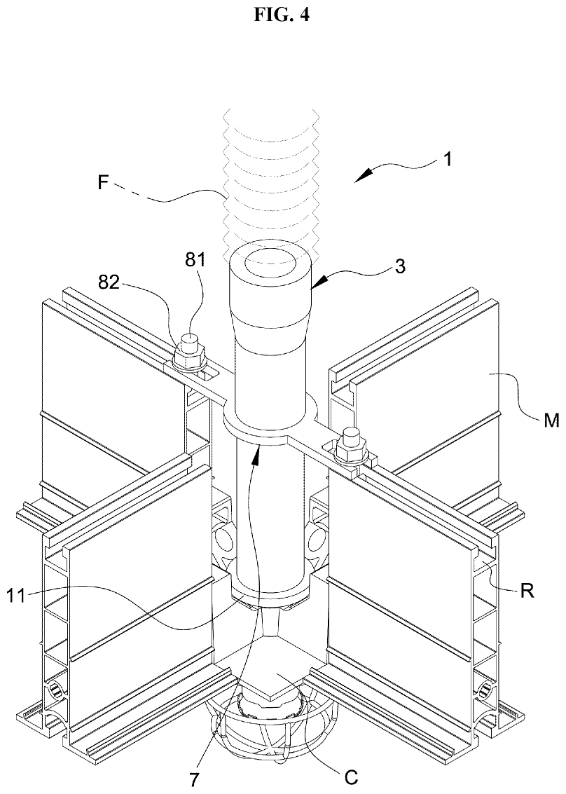

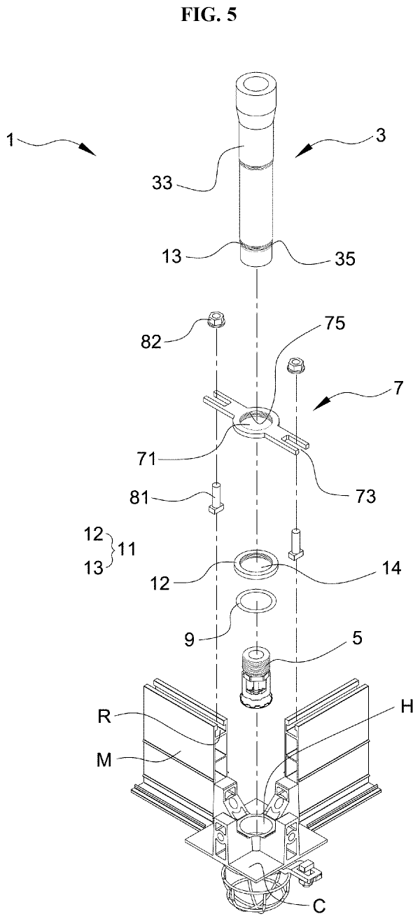

The dustproof sprinkler of the present invention is an equipment for extinguishing a fire inside a facility requiring dustproofing, such as a clean room, and comprises a headnipple 3, a head 5, a headnipple support 7, a shield ring 9, and a shield ring pressing means 11, as shown in FIGS. 4 and 5 with a drawing designation 1.

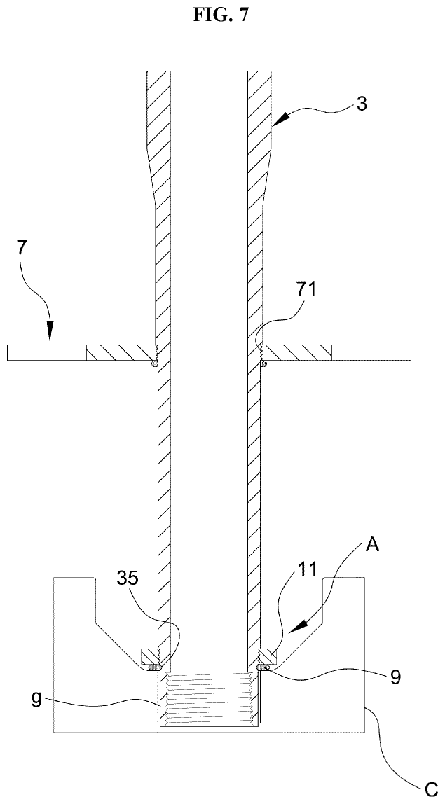

Here, the headnipple 3 is a pipe connecting a sprinkler head 5 that sprays fire extinguishing water supplied from a water source and a flexible pipe F connected to the water source to supply the fire extinguishing water, and is inserted through a ceiling member C forming a ceiling of a clean room or the like, as shown in FIG. 4, a head 5 having an upper end coupled to the flexible pipe F above the ceiling member C and connected to a water source, and a lower end coupled to the ceiling member C through a through hole H formed in the ceiling member C, for example as shown in FIGS. 5 and 7.

The head 5 is a spraying means coupled to the lower end of the headnipple 3 for spraying fire extinguishing water into the interior of the facility as described above, and is removably mounted on the lower end of the headnipple 3, as shown in FIGS. 4 and 5. Thus, the head 5 performs a fire extinguishing operation by spraying fire extinguishing water supplied from a water source through the headnipple 3 into the interior of the facility in the event of a fire.

The headnipple support 7 is a support means for securing the headnipple 3, which is disposed above the ceiling member C, to the ceiling member C. As shown in FIGS. 4 and 5, the headnipple support 7 is removably screwed to an outer circumferential end of the headnipple 3. That is, for example, as shown in FIGS. 5 and 7, the headnipple support 7 may be in the form of a wide bar with an insertion hole 71 machined in the center, wherein the insertion hole 71 is not only adapted to receive and pass through the headnipple 3, but is also removably engaged with the inserted headnipple 3. For example, the insertion hole 71 and the headnipple 3 may be snapably and detachably coupled by a multi-stage concave structure that interengages with each other, although not shown. In this embodiment, as shown in FIGS. 5 to 5, a female threaded member 75 is machined on the inner circumferential surface of the insertion hole 71, and a male threaded member 33 is machined on the corresponding portion of the headnipple 3 to the insertion hole 71, so that the male threaded member 33 is removably coupled to the insertion hole 71 by screwing.

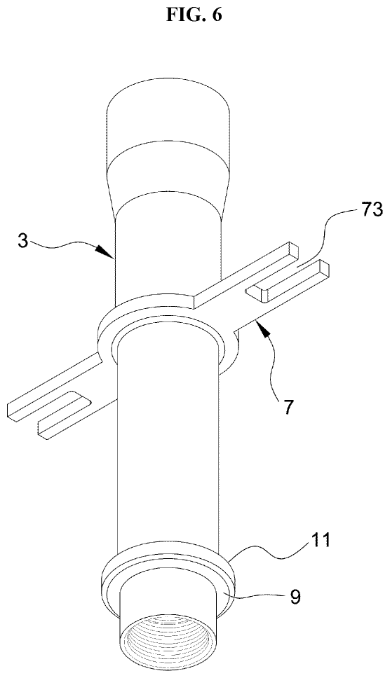

On the other hand, the headnipple support 7 is coupled to the top of the ceiling member C with the headnipple 3 inserted as shown in FIG. 4, such as a bar for securing the headnipple 3 to the ceiling member C, for example, A mold bar M erected and installed in a grid arrangement on the ceiling member C is removably coupled with bolts 81 and nuts 82, for which the headnipple support 7 may be formed in a U-shape with fastening slots 73 at both ends, as shown in FIGS. 4 to 6. In this case, the mold bar Mis formed with a T-shaped rail groove R at the top edge, so that the bolt 81 is vertically upright with the head portion inserted into the rail R, and the headnipple support 7 is removably secured to the top of the mold bar M by engaging the bolt 81 with the body portion inserted into the fastening slot 73.

However, before the headnipple 3 is secured to the top of the mold bar M by the headnipple support 7 as above, the lower end of the headnipple 3 is first inserted into the through hole H of the ceiling member C, as shown in FIGS. 4 and 7, and the sprinkler head 5 at the lower end is exposed through the through hole H into the interior of the facility under the ceiling. In this way, the bolts 81 and nuts 82 are securely fastened, the headnipple support 7 is lowered and pressed firmly against the rail R, in this process, the headnipple 3 descends with the headnipple support 7, and accordingly, as will be described later, the shield ring pressing means 11 also descends, forcing the shield ring 9 onto the top of the gap g.

The shield ring 9 is a means for sealing the gap g that occurs between the inner surface of the through hole H and the outer surface of the headnipple 3 when the headnipple 3 is inserted into the through hole H of the ceiling member C, as shown in FIG. 4, A shield ring 9 is fitted on the outer circumferential surface of the headnipple 3, which is positioned lower than the headnipple support 7, to seal the gap g between the inner circumferential surface of the through hole H of the ceiling member C and the outer circumferential surface of the headnipple 3. For this purpose, the shield ring 9 is formed so that its outer diameter is larger than the inner diameter of the through hole H, as shown in FIG. 7, so that the top of the gap g can be sealed and closed in such a way that the top of the gap g is covered without being stuck in the gap.

Accordingly, the operator inserts the headnipple 3 into the through hole H of the ceiling member C with the headnipple support 7 inserted into the insertion hole 71 of the headnipple support 7, and secures the headnipple support 7 to the top corner face of the mold bar M with bolts 81 and nuts 82, The headnipple 3 is pushed down along with the headnipple support 7 so that the shield ring 9 is pressed against the top of the gap g by the shield ring pressing means 11 described later, so that a seal against the top of the gap g can be achieved.

At this time, the female threaded member 75 is machined on the inner circumferential surface of the insertion hole 71 drilled in the headnipple support 7 for inserting the headnipple 3, as shown in FIG. 5, and the male threaded member 33 is machined on the outer circumferential surface of the headnipple 3 for screwing into the female threaded member 75 when the headnipple 3 is inserted into the insertion hole 71, as shown in FIG. 5. Thus, the headnipple 3, which is inserted into the insertion hole 71 and coupled to the headnipple support 7, is raised within the through hole H in accordance with the upward and downward movement of the headnipple support 7.

On the other hand, on the outer circumferential surface of the headnipple 3 where the shield ring 9 is located, a ring groove 35 for fitting and restraining the shield ring 9 may be concavely formed as shown in FIGS. 5 and 7. However, since the shield ring 9 does not need to be tightly fitted into the ring groove 36, the shield ring 9 may have an outer diameter such that little internal stress is generated when it is fitted into the ring groove 36.

The shield ring 9, which is thus fitted and secured in the ring groove 35, rises with the headnipple 3. As a result, when the headnipple 3 descends with the headnipple support 7 as described above, they can descend together to provide a strong seal at the top of the gap g.

The shield ring pressing means 11 is a ring-shaped member projecting from the outer circumferential surface of the headnipple 3, as shown in FIGS. 4 to 7, which can be made in the form of a nut having a female threaded hole 14, as shown in FIG. 5, This nut-shaped shield ring pressing means 11 may comprise a ring flange 12 with a female threaded hole 14 and a male threaded portion 13 machined directly above the ring groove 35 at the bottom of the outer circumferential surface of the headnipple 3. In this case, the shield ring compression means 11 may be removably mounted via a threaded connection of the ring flange 12 and the male threaded portion 13, and in other cases, the shield ring compression means 11 may be integrally formed by welding or the like to the outer circumferential surface of the headnipple 3.

Thus, the shield ring pressing means 11 descends with the headnipple support 7 while the headnipple 3 is inserted into the through hole H, thereby strongly compressing the shield ring 9 against the top of the gap g, thereby providing a more robust seal against the gap g. In this case, the ring groove 35 can be omitted as the shield ring pressing means 11 fulfills this role. Furthermore, the removable shield ring pressing means 11 can adjust the gap between the ring flange 12 and the shield ring 9, i.e., the distance from the ring flange 12 to the gap g, by rotating the ring flange 12, so that it is possible to respond to changes in the thickness of the shield ring 9 and, for one shield ring 9, to change the intensity with which the shield ring 9 is first compressed during assembly of the headnipple 3. For example, if the thickness of the shield ring 8 is greater than the distance between the gap g and the ring flange 12, the shield ring pressing means 11 presses and deforms the shield ring 8 as soon as the headnipple 3 is inserted into the through hole H, and the closer the distance from the gap g to the ring flange 12, the stronger the pressing force.

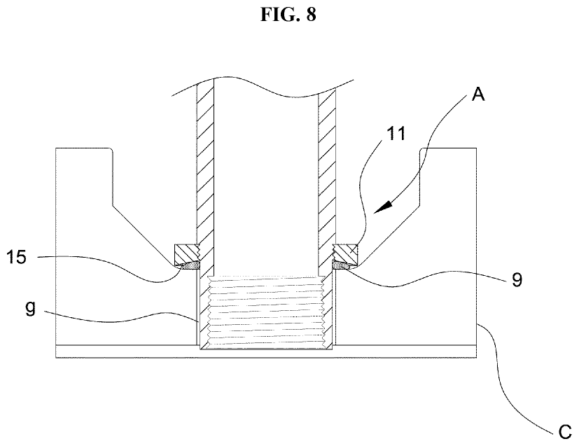

On the other hand, the ring flange 12 is shaped like a lampshade in cross-section, as shown in FIG. 8, with the lower surface 15 in contact with the shield ring 9 sloping upwardly the closer it is to the female threaded hole 14, so that the shield ring 9, which is compressed by the comb effect of the sloping lower surface 15, can be deformed to fit more closely into the gap g, thereby doubling the sealing performance for the gap g.

Now, the action of the dustproof sprinkler 1 according to a preferred embodiment of the present invention will be described as follows.

According to the dustproof sprinkler 1 of the present invention, when installing the sprinkler 1 on the ceiling of a facility requiring extreme dustproofing, such as a clean room for semiconductor manufacturing, the ceiling can be made in various forms. For example, conventionally, a ceiling member such as a ceiling panel is simply installed through a support frame, and a through hole is formed at any location in the ceiling panel through which a sprinkler can be installed.

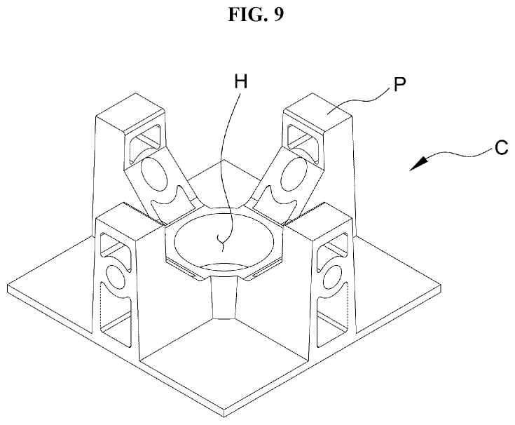

However, in order to use the ceiling panel (not shown) as a filter, the present invention separately manufactures the ceiling member C and the ceiling panel as shown in FIG. 9, connects the mold bar M through the fixed protrusion P of the ceiling member C, and completes the ceiling by arranging the ceiling panel in a grid form through the ceiling member C and the mold bar M, and the sprinkler 1 is installed through the ceiling member C as shown.

Thus, in order to install the sprinkler 1 through the ceiling member C as described above, the headnipple 3 is positioned from the top of the outer circumferential surface of the headnipple 3, followed by the headnipple support 7, the shield ring pressing means 11, the shield ring 9, and the sprinkler head 5 at the bottom, as shown in FIGS. 4 to 7.

Here, the headnipple support 7 is removably fixed to the mold bar M via bolts 81 and nuts 82, as mentioned above, to support the headnipple 3. At this time, the headnipple support 7 is pressed against the rail R of the mold bar M, and in the process, the headnipple 3 is lowered.

Meanwhile, the shield ring 9 is fitted on the lower side of the outer circumferential surface of the headnipple 3 or in the ring groove 35, and when the headnipple 3 is lowered along with the headnipple support body 7 as described above, it is pressed downward by the shield ring pressing means 11 to press the top of the gap g that occurs between the through hole H and the outer circumferential surface of the headnipple 3 to close it. Accordingly, the shield ring 9 is able to maximize the sealing force of the gap g, thereby doubling the dustproof performance of the sprinkler 1 for facilities requiring dustproofing such as clean rooms.

While specific embodiments of the invention have been described above by way of example, they are for illustrative purposes only and are not intended to limit the scope of protection of the invention. That various substitutions, modifications and changes are possible without departing from the technical idea of the invention will be apparent to one having ordinary knowledge in the technical field to which the invention belongs.

### INDUSTRIAL APPLICABILITY

The present invention enables a stronger compression of the shield ring that seals the gap between the headnipple and the ceiling member through the shield ring compression means that descends with the headnipple when the headnipple descends, so that the sealing force of the shield ring on the gap can be greatly increased, and the dustproof performance of the sprinkler for dustproof facilities such as clean rooms can be maximized.

1. A dustproof sprinkler comprising:
a headnipple (3) having a first end connected to a water supply source above a ceiling member (C), and a second end fitting into the ceiling member (C) through a through hole (H);
a head (5) removably mounted on the second end of the headnipple (3), which sprays extinguishing water supplied through the headnipple (3) from the water supply source;
a headnipple support (7), coupled to extend outwardly from an outer surface of the headnipple (3), and removably fixed to a ceiling member (C), thereby securing the headnipple (3) to the ceiling member (C);
a shield ring (9), formed to have an outer diameter larger than an inner diameter of the through hole (H), which is fitted to an outer circumferential surface of the headnipple (3) at a position above the through hole (H) so as to block the top of a gap (g) that occurs between the through hole (H) and the headnipple (3) when the headnipple (3) is inserted into the through hole (H); and
a shield ring pressing means (11) for pressing the shield ring (9) to seal the top of the gap (g) when the headnipple support (7) is fixed on top of the ceiling member (C).

2. The dustproof sprinkler of claim 1, wherein the shield ring pressing means (11) is liftably mounted on the outer circumferential surface of the headnipple (3), so that the distance to the top of the gap (g) can be adjusted to the thickness of the shield ring (9).

3. The dustproof sprinkler of claim 2, wherein the shield ring pressing means (11) comprises:
a ring flange (12) having a female threaded hole (14) machined in its center; and
a male threaded portion (13) removably screwed into the female threaded hole (14), for mounting the ring flange (12) raisably to an outer circumferential surface of the headnipple (3).

4. The dustproof sprinkler of claim 3, wherein the headnipple (3) comprises a ring groove (35) concavely formed on the periphery of the male threaded portion (13) for fitting and binding the shield ring (9).

5. The dustproof sprinkler of claim 3, wherein the ring flange (12) is inclined in the form of a shroud so that the lower surface in contact with the shield ring (9) is upwardly inclined the closer it is to the female threaded hole (14).
